(19) United States
(12) Patent Application Publication
(10) Pub. No.: US 2013/0016847 A1
(43) Pub. Date: Jan. 17, 2013

(54) METHOD AND APPARATUS FOR ACTIVE SOUND MASKING

(71) Applicant: Arndt STEINER, Leverkusen (DE)

(72) Inventor: Arndt STEINER, Leverkusen (DE)

(73) Assignee: PINTA ACOUSTIC GMBH, Maisach (DE)

(21) Appl. No.: 13/545,142

(22) Filed: Jul. 10, 2012

(30) Foreign Application Priority Data
Jul. 11, 2011 (DE) 10 2011 051 727.8

(51) Int. Cl. H04R 3/02

(52) U.S. Cl. 381/73.1

(57) ABSTRACT

A method for influencing noise in a space, such as an open-space office, whereby active sound suppression and/or sound masking is/are undertaken. In order to advantageously undertake active sound suppression or sound masking in a larger space, for example an open-space office, a plurality of sound actuators are provided distributed over the surface area of the space, and at least one sound sensor is disposed in the space, and two or more of the sound actuators are acted on differently, with regard to sound values detected by the sound sensor and/or with regard to a desired sound-related space division and/or as the result of person signals or object signals that are detected.

### CROSS REFERENCE TO RELATED APPLICATIONS

Applicant claims priority under 35 U.S.C. §119 of German Application No. 10 2011 051 727.8 filed Jul. 11, 2011, the disclosure of which is incorporated by reference.

### BACKGROUND OF THE INVENTION

1. Field of the Invention

The invention relates to a method for influencing noise in a space, such as, for example, an open-space office, in which active sound suppression and/or sound masking occurs.

2. The Prior Art

Such methods have already become known in various respects. Work is performed with a sound source that is adjusted, with regard to a disruptive sound source, in such a manner that the sound waves cancel one another out to the greatest possible extent. An example of this is described in U.S. Pat. No. 7,272,234 A.

### SUMMARY OF THE INVENTION

It is an object of the invention to advantageously undertake active sound suppression or sound masking in a larger space, for example an open-space office.

To accomplish this task, a method for active sound suppression in a space is indicated, in a plurality of sound actuators are provided distributed over the surface area of the space, at least one sound sensor is disposed in the space, and two or more of the sound actuators are acted on differently with regard to sound values detected by the sound sensor. It is essential that in the space in which the sound profile is supposed to be influenced, in whole or in part, the sound actuators are acted on differently with regard to detected sound sources, to generate the active noise control for sound suppression or to generate sound for sound masking. Microphones, in particular, are possibilities for sound sensors. This can involve one or more microphones that are disposed distributed in the space. The sound actuators can be sound sources such as loudspeakers, for example.

It is preferred that not only a plurality of sound actuators but also a plurality of sound sensors are provided. Both can be provided distributed in the space, preferably uniformly. With regard to the sound sensors, directed sound sensors, such as directional microphones, can also be used. In this way, it is evident that a sound situation in a region of the space in which such a sound sensor is not disposed directly or centrally can also be detected.

Sound masking can serve to even out a constantly varying noise level in a space, for example an open-space office, and to thereby achieve greater acoustical comfort. This can involve a uniform noise that cannot be assigned to an identifiable sound source. This is generally perceived as being less disruptive than a structured noise that is generated in a specific time sequence and/or with a specific frequency spectrum and/or with a specific signal interval. With the sound masking, the result is achieved that even in the case of varying occupancy of a large space by persons, in other words the difference between a completely occupied or only partially occupied open-space office, approximately the same impression in terms of sound is imparted. Furthermore, specific conversations that take place in a region of the space cannot be identified, with regard to the words, in another region of the space.

The embodiments described here can particularly find use in large offices used by human beings, such as open-space offices, for example, but also in schoolrooms, financial institutions, for example a tellers' area of a bank, hotel areas, for example a hotel lobby, etc.

In a further embodiment, action on the sound actuators is undertaken in accordance with a sound source that moves over the surface area of the space. Such a sound source can exist, for example, in the form of a device moving through the space, such as a floor cleaning machine, but also in the form of a group of persons moving through the space, in which the persons are speaking with one another. Detection of a moving sound source or of a moving accumulation of sound sources such as several persons of the group of persons, for example, can then be analyzed in usual manner, with regard to the sound values detected by the one or multiple sound sensors, and a corresponding active noise control can be generated, or an additional sound can be superimposed. This sound can then be “transferred,” so to speak, as this sound source moves through the space, to other sound actuators that are disposed distributed over the space, in the movement direction or approximately in the movement direction of the sound source.

Also, a specific region of a space can become a discretion zone, by means of targeted emission of sound by way of individual sound actuators, in which zone the sound emission is controlled so that conversations conducted in this region of the space cannot be understood outside of this region of the space. In particular, such a discretion zone can also be configured as migrating through a space with persons and/or devices.

It is also possible that a person and/or a device gives off recognition signals, for example wireless signals, which are emitted by a wireless transmitter situated on the person or the device or object (this can also be a Smart Phone and/or an (admission) chip card, for example), and that a corresponding wireless receiver is provided, assigned to the control unit for influencing noise, which receiver can identify a specific person or a specific object in this way, and accordingly, this person or this object has special active noise control configurations or special sound masking assigned to him/her/it, and/or special discretion zones that migrate with the object or the person, if applicable, in the manner described, are created. With regard to the control for the sound actuators that is provided in any case, and the possible, described detection of recognition signals, for example wireless signals, which are emitted by a person or an object, it can also be provided that these signals are additionally or alternatively used to control sound emission for controlling lighting. For example, when sound is detected only in a specific region of a space, lighting can be limited to this region, or when specific signals are detected, which are assigned to specific persons such as security personnel, for example, the lighting can be intensified.

Furthermore, it is also preferred that the detection of sound by way of the sound sensor is used to monitor presence or to monitor entry, for example by means of coupling with an alarm system. In this way, in the event of detection of a sound value during a time period when the alarm system does not expect any sound values, significant sound is produced in the region or space section in question, which can lead supervisory personnel to this region immediately. If the detected sound source then migrates through the space, the active noise control generated can also migrate through the space with this sound source, accordingly.

With regard to the placement of the sound actuators, it is furthermore preferred that these are disposed on the ceiling side and/or wall side in the space. They are preferably also installed in other objects, for example in a so-called suspended ceiling panel or an acoustic wall part. This can be a sound absorber that is disposed on the wall side or ceiling side in such a space. Preferably, multiple suspended ceiling panels or sound absorbers as such or ceiling or wall elements as such are then disposed in such a space. With regard to the configuration of such a suspended ceiling panel or sound absorber, reference is made, for example, to European Patent Application No. EP 1 918 472 A1, and German Patent Application Nos. DE 20 2007 016382 U1, DE 20 2009 013052 U1 and DE 20 2008 008896 U1. The disclosure of all of these patent applications is hereby incorporated by reference.

Furthermore, it is preferred that the sound sensor and/or the sound actuator are disposed in such a sound absorber or ceiling element in general, particularly a suspended ceiling panel. This means that they can preferably be controlled in a wireless manner, for example by way of wireless signals, and furthermore that an autarchic power supply, for example by way of a rechargeable battery, is provided for a sound sensor and/or a sound actuator, within the ceiling element.

A sound absorber to be attached preferably to a ceiling of a space, having a foam material surface part, for example, is also an object of the invention. With regard to such a sound absorber, the task arises of improving the effectiveness for sound suppression or sound masking.

This task is accomplished by a sound absorber that is structured so that it has a sound source.

Preferably, the sound absorber has a sound source'in the form of a loudspeaker. This can also be a membrane film that is excited to produce sound, for example. Furthermore, the sound source that is provided in the sound absorber can preferably be controlled as a function of a detected sound, namely for active sound suppression, in such a manner that it emits a sound that leads to canceling out the disruptive sound, to the greatest extent possible, or that leads to the desired superimposition of the existing sound field, in order to mask a local conversation.

Furthermore, it is preferred that the sound absorber has a sound sensor, preferably in the form of a microphone.

Furthermore, it is preferred that sound emission of the sound source can be carried out as a function of a sound source that is provided in the space, if applicable in a movable manner.

Even though reference is made to sound absorbers on a foam material basis above and below, with regard to the ceiling and wall elements, it should be understood that fundamentally all elements that have a sound effect, for example also on the basis of a porous stone or the like, can be equipped with sound actuators and/or sound sensors in the manner described here.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic view of a space with objects disposed in it, which have a sound actuator and/or a sound sensor; and

FIG. 2 shows a perspective view of a space and sound absorbers disposed in it on the ceiling side, further having a sound actuator and/or a sound sensor.

### DETAILED DESCRIPTION OF THE PREFERRED EMBODIMENT

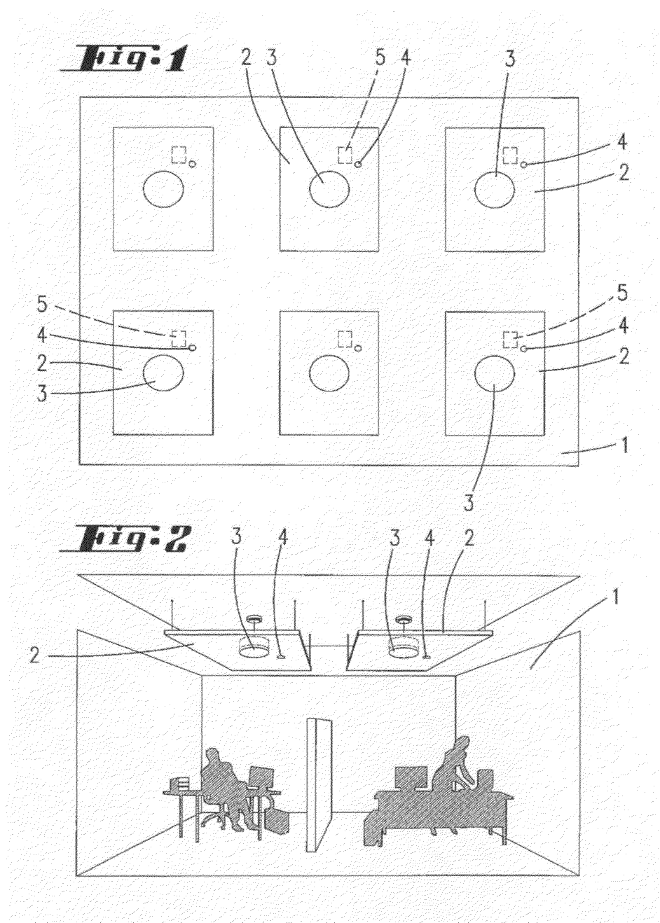

Referring now in detail to the drawings, in FIG. 1, schematic space 1 is shown and described, in which sound absorbers 2 are disposed on the wall side and/or ceiling side (in the exemplary embodiment, only wall-side sound absorbers 2 are shown). These are preferably foam material sound absorbers, as explained above. In a simple case, a sound absorber consists of a self-supporting sound absorber part that is affixed on the ceiling side or wall side by way of attachment rods or attachment elements. This can particularly be a foam material part, preferably on the basis of melamine resin foam material, which is accommodated in a frame part that surrounds it at its edges. Attachment to the ceiling and/or the wall preferably takes place by way of the frame part. Reference is furthermore made to the documents already cited.

In the sound absorber 2, sound actuators 3 and/or sound sensors 4 are provided; these are only indicated schematically here.

Furthermore, a rechargeable battery 5 is provided, in or assigned to the sound absorber 2, to provide power to the sound actuator 3 and/or the sound sensor 4. However, a direct power supply can also be provided, particularly if the sound absorber 2, as is fundamentally known, is equipped with lighting units, which require a power supply in any case.

With reference to FIG. 2, a schematic perspective view of a space 1 is reproduced, in which the sound absorbers 2 with the sound actuators 3 and/or the sound sensors 4 are disposed on the ceiling side.

The sound determined by way of sound sensors 4 is analyzed in a computer unit, as shown in detail, and then an active noise control or a sound masking sound is generated, by way of the sound actuators 3, which sound, in the case of the active noise control, is directed preferably completely, but in any case essentially or to a significant extent, in the opposite direction, so that the sound and the active noise control cancel one another out.

In particular, migration of a sound source through such a space can also be detected one or more sound sensors 4, and a corresponding active noise control or masking sound can be “transferred” from one sound actuator 3 to another. Also, individual discretion zones, as already explained above, can be formed and, if applicable, can also be provided to “migrate.”

The sound absorbers 2 or special corresponding suspended ceiling panels are preferably provided in such a manner that about 20 to 60% of the ceiling and/or wall surface area, preferably about 40% of the ceiling and/or wall surface area are covered by them, in a projection onto the ceiling or wall surface area.

The rechargeable batteries 5 are preferably provided in such a manner that they are maintenance-free over a very long period of time, for example 1 to 2 years. It can also be provided that the charging state of a rechargeable battery 5 is transmitted by wireless or WLAN, and can be queried in this manner.

In particular, the sound actuators and/or the sound sensors work in a frequency range of about 100 Hz to 2 kHz, and preferably in a range of 125 Hz to 1 kHz.

The disclosure content of the related priority application is hereby also included in the disclosure content of this application, with its full content, also for the purpose of including characteristics of these documents in claims of the present application

Accordingly, while only a few embodiments of the present invention have been shown and described, it is obvious that many changes and modifications may be made thereunto without departing from the spirit and scope of the invention.

### REFERENCE SYMBOL LIST

1 space
2 sound absorber
3 sound actuator
4 sound sensor
5 rechargeable battery

What is claimed is:

1. A method for influencing noise in a space, wherein active sound suppression and/or sound masking is undertaken, comprising the following steps:
providing a plurality of sound actuators distributed over a surface area of the space;
providing at least one sound sensor disposed in the space; and
actuating two or more of the sound actuators in response to sound values detected by the sound sensor, or with regard to a desired sound-related space division, or as a result of person signals or object signals that are detected by the sound sensor.

2. The method according to claim 1, wherein a plurality of sound sensors are provided.

3. The method according to claim 1, wherein the step of actuating the sound actuators is undertaken in response to a sound source that moves over a surface area of the space.

4. The method according to claim 1, wherein the sound actuators or the sound sensors are disposed in a ceiling or wall of the space.

5. The method according to claim 4, wherein at least one of the sound actuators or a sound sensor is disposed in a ceiling element.

6. The method according to claim 1, wherein presence monitoring or access entitlement or regulation or control of lighting is carried out using the sound sensor.

7. A sound absorber to be attached to a ceiling of a space, wherein the sound absorber has a sound actuator.

8. The sound absorber according to claim 7, wherein the sound actuator in the form of a loudspeaker.

9. The apparatus according to claim 7, wherein the sound absorber has a sound sensor in the form of a microphone.

10. The apparatus according to claim 7, wherein sound emission of the sound actuator is carried out as a function of a sound source.
